(19) United States
(12) Patent Application Publication
(10) Pub. No.: US 2002/0116215 A1
(43) Pub. Date: Aug. 22, 2002

(54) Method and system for administering an on-line fund-raising event

(76) Inventors: Jay Lawrence, Bellmore, NY (US); Jodie Fineman, Plainview, NY (US)

Correspondence Address: PENNIE AND EDMONDS, 1155 AVENUE OF THE AMERICAS, NEW YORK, NY, 100362711

(21) Appl. No.: 10/077,192

(22) Filed: Feb. 15, 2002

Related U.S. Application Data
(60) Provisional application No. 60/269,437, filed on Feb. 16, 2001.

(51) Int. Cl. G06F 17/60

(52) U.S. Cl. 705/1

(57) ABSTRACT

A fund-raising method and system relating to the planning and administration of fund-raising events such as live auctions, on-line sales, and on-line auction events. In a preferred aspect, a centralized Web site accessible by network users is provided and maintained for hosting on-line fund-raising auctions of goods or services in the name of fund-raising entities, where the goods or services are not owned or provided by the fund-raising entities, and preferably are provided or owned by the host of the fundraising event or host of the Web site. The goods or services are auctioned to users visiting the Web site, payment from a user successfully bidding on a good or service for auction is received and a portion of the payment preferably is allocated to the fund-raising entity. A rebate may be provided to the fund-raising organization proportional to a total amount of revenue generated during a fund-raising event, the rebate may be applicable to the cost of future fund-raising events. A communication network-based system and software program for implementing the present invention are also disclosed.

### RELATED APPLICATIONS

This application claims priority to U.S. provisional patent application serial No. 60/269, 437, filed Feb. 16, 2001.

### FIELD OF THE INVENTION

The present invention relates generally to electronic commerce and fundraising. More particularly, the present invention relates to a method and system for fundraising which takes into account live auctions, on-line sales and on-line auction events. In one aspect, the present invention relates to a communication network based method and system for hosting on-line fund-raising auctions and sales on behalf of fund-raising entities like charitable organizations and other special interest groups.

### BACKGROUND OF THE INVENTION

As used herein, the term computer includes any device or machine capable of accepting data, applying prescribed processes to the data, and supplying the results of the processes. By way of example, but not limitation, the term “computer” includes mainframe computers, servers, personal computers, laptops, personal digital assistants, portable phones, cell phones and calculators. The term “communication network” is also meant in a broad sense, and may include any suitable technology for information transmission, including electrical, electromagnetic and optical technologies. Such a communication network may link computers, e.g., a LAN or WAN. Although the invention is described with particular reference to an open network, such as the Internet, it may also be used in other networks, internets and intranets.

The Internet continues to increase in importance as a place for business, offering a wide variety of information and services to potential customers, and providing businesses with a new and efficient way to reach their target audiences. But the applications and efficiencies of what has become known as “e-commerce” are not limited to pure for-profit businesses. The efficiencies of e-commerce may also be utilized for fund-raising events held by fund-raising groups or entities like charitable organizations, “non-profit” entities, and other special interest groups who seek to raise monies for their respective causes. As used herein, the terms “fund-raising entity,” “fund-raising group,” and “fundraising organization,” and plural derivatives thereof, are interchangeable and include conventional charities, such as churches and other organizations dedicated to helping the poor or infirm or fighting a disease (e.g., AMERICAN CANCER SOCIETY®, AMERICAN LUNG ASSOCIATION®), non-profit organizations, such as those dedicated to educating the less fortunate, and any other special interest groups seeking to raise funds for a cause. The term fund-raising entity may also include a corporation sponsoring a fund-raiser for the benefit of a charity or special interest group, or to raise funds for a recreational employee event.

In the past, fund-raising groups have often held live fund-raising events, such as live auctions or sales, where donated goods or services are purchased by interested consumers who know that the proceeds from the event will benefit the cause associated with the fund-raising group. For example, a well-known artist might donate an original print of one of his or her works to a charity so that it may be auctioned off to those interested in the charitable cause and/or the artist's work. In this example, since the artwork has been donated to the charity, the charity will keep the majority, if not all, of the proceeds from the sale. Typically, however, fund-raising groups must spend valuable time and resources organizing and administrating the fund-raising event, and soliciting donations of goods and services from those willing to support their cause. In addition, these auctions and live events would span a short duration of time during which sales would take place.

Auction systems for auctioning goods on the Internet are disclosed in U.S. Pat. Nos. 5,835,896 to Fisher et al. and 5,890,138 to Godin et al. The Fisher and Godin patents relate generally to systems for posting items for sale on the Internet and receiving bids from interested consumers. U.S. Pat. No. 6,108,639 to Walker et al. discloses a “buyer driven” system where consumers submit conditional purchase offers for specified collectible items via the Internet, and those offers are provided to potential sellers for possible acceptance. U.S. Pat. No. 6,052,674 to Zervides et al. relates to an electronic invoicing and collection system for encouraging the payment of late payment surcharges where a portion of the late payment surcharge is apportioned to a charity.

Other Web sites for on-line auctioning of goods and services include EBAY™, <<http://www.ebay.com >>, which allows individual sellers to auction their goods to other Internet users, and UBID™, <<http://www.ubid.com >>, which provides a forum for vendors to auction goods to Internet users. In both of these systems the Web site administrator is believed to receive only a small commission for each sale and the items being auctioned are owned/provided by a third-party seller distinct from the Web site administrator.

### SUMMARY OF THE INVENTION

It is desirable, therefore, to augment traditional fund raising activities such as the live auction with events, auctions and selling activities which raise money for a cause that can take place day and night and over a greater period of time so that more funds can be raised. It is desirable to enable fund-raising groups to incorporate the transaction efficiencies of the Internet into their fund-raising activities. Such a method and system would provide a forum where such groups can host on-line fund-raising events, either in place of, or as an augmentation of, live fund-raising events, such that all interested donors or participants can participate no matter what time or where they are located physically. In one aspect of the present invention, fund-raising entities would not have to expend significant time and resources organizing live events and/or providing a suitable locale for a live auction event. In another aspect, fund-raising entities who are planning fund-raising events could raise funds on-line immediately by advertising their involvement with an online host and providing their members with the host Web site address, fund-raising passwords and/or codes to be used on-line at the Web site to designate a portion of the proceeds from consumer purchases for the benefit of the fund-raising cause. The fund raising program could involve live auctions, on-line selling and on-line auction events.

In one embodiment a method and system for administering an on-line fundraising auction via a communication network, such as the Internet, is disclosed.

In a preferred embodiment, the present invention relates to a communication network-based method for administering a fund-raising program. A Web site accessible by network users is provided and maintained by a host or marketing event planner. The Web site preferably is configured for conducting and hosting fund-raising activities including preferably planning and coordinating live auctions and other live fund-raising activities, online selling and on-line auctions of goods or services. The goods and services may be owned, obtained or provided by the host or marketing event planner. The goods or services may be auctioned to users visiting the Web Site. Alternatively, the host could have an event or program that includes live (i.e., in person) and an on-line components, so that interested consumers could purchase items for a fund-raising whether at one of the live events or even if they were not able to physically attend the live component of the event or program. For example, the fund raising program or event may include an on-line store, live auction events and on-line auction events which can offer identical goods, related or complimentary goods. The on-line auction component may be public or private, and the goods or services to be auctioned may include artwork, memorabilia, or collectibles. The goods or services may be purchased by the host from an unrelated entity in the business of selling such goods and may be purchased for the purpose of selling as part of the fund raising program including the on-line auction event. The event planner who plans and organizes the event may be paid by a percentage of the goods sold or a set price for the planning, organization, and promotional services. A portion of the proceeds from the sale of the goods may be allocated to the fund-raising entity in whose name the auction may be promoted. Alternatively or additionally, the fund-raising entity in whose name the auction is held may receive a flat rate. The event planner may host or own the Web site, and may be paid a percentage of the goods sold and a set fee.

Additionally, a rebate may be calculated and provided to the fund-raising organization proportional to a total amount of revenue generated during a fund-raising event. Alternatively or additionally, the rebate or discount voucher may be applicable to the cost of future fund-raising events, or used by the fund-raising entity to purchase items for auction at future live events. A rebate may also be provided to a network user who has purchased one or more auction items, where the rebate may be applicable to future purchases at the Web site either during a current or future event. In one variation, items complementary, related or similar to the goods or services auctioned may be offered for sale at a fixed price to network users before, during, or after the auction has closed. These sales may take place via an on-line store also maintained at the Web site, enabling a fund-raising entity to raise funds all year long, day or night.

In another preferred embodiment, one aspect of the present invention relates to a communication network-based system for administering a fund-raising program. The system may include a server computer for maintaining a Web site accessible by network users which may include a database for storing information related to fund-raising entities and items for auction, a communications link for receiving information, data and/or bids from users for items, events and a processor running software for displaying information about items, processing information, data and bids from network users, determining winning bidders, or any combination of these functions. The Web site preferably is configured to host an auction of goods or services in the name of a fund-raising entity (e.g., AMERICAN CANCER SOCIETY®), where the goods or services are not owned or provided by the fund-raising entity. The auction may be public—open to all network users, or access may be restricted to a specified set of users (for example, charity members). In the latter case, users may be required to enter a password and/or user name to access the auction.

The server computer may be configured to receive payment from a user successfully bidding on a good or service for auction, and the processor may allocate a portion of the payment to the fund-raising entity. The processor may be further configured to calculate a rebate to the fund-raising entity proportional to a total amount of revenue generated during a fund-raising event or program, or calculate a discount applicable to the cost of future fund-raising events or programs. The discount for future events may be calculated using a different formula (e.g., more favorable to the fund-raising entity) to provide an incentive for the fund-raising organization to use the discount in the future and have the host plan another event or program rather than use the rebate for an immediate pay off. The processor may still further be configured to offer for sale, at a fixed price, items complementary or similar to the goods or services auctioned before, during or after the auction has closed.

In still another embodiment, the system relates to a software program implemented on a host computer in a communication network-based system for administering an on-line fund-raising event. The software program configures the host computer to maintain a Web site accessible by network users, host a fund-raising auction of goods or services in the name of a fund-raising entity where the goods or services for auction may not be owned or provided by the fund-raising entity, receive payment from a user successfully bidding on a good or service for auction, and allocate a portion of the payment to the fund-raising entity. The software program may further configure the host computer to provide a rebate to the fund-raising organization proportional to a total amount of revenue generated during a fund-raising event, and the rebate may be used to offset the cost of future fund-raising events. The software program may still further configure the host computer to offer for sale at a fixed price items complementary or similar to the goods or services auctioned before, during, and after the auction has closed. A percentage of the fixed price items may also be allocated to the fund-raising organization so that the fundraising organization has incentive to direct users to the host Web site.

### BRIEF DESCRIPTION OF THE DRAWINGS

The present invention will be understood and appreciated more fully from the following detailed description, taken in conjunction with the drawings in which:

FIG. 1 is a block diagram illustrating the operation of a system of the present invention;

FIG. 2A is a flowchart illustrating the steps in a preferred embodiment of the method of the present invention; and

FIG. 2B is a continuation of the flowchart of FIG. 2A, illustrating still more steps in a preferred embodiment of the method of the present invention.

### DETAILED DESCRIPTION OF THE PREFERRED EMBODIMENTS

The present invention in one embodiment relates to a method and system for administering an on-line fund-raising event in the name of a fund-raising organization via a communication network, such as the Internet. Unless otherwise indicated expressly or by context, a “good” encompasses a deliverable, including a physical good, an electronic or virtual good and a service which provides a physical, electronic or virtual deliverable. The terms “user”, “purchaser”, “customer”, “consumer”, “recipient” and “orderer” are used interchangeably unless indicated otherwise expressly or by context. Similarly, the terms “seller”, “vendor”, “retailer”, “merchant”, “provider” or “sender” of a good are used interchangeably unless indicated otherwise expressly or by context.

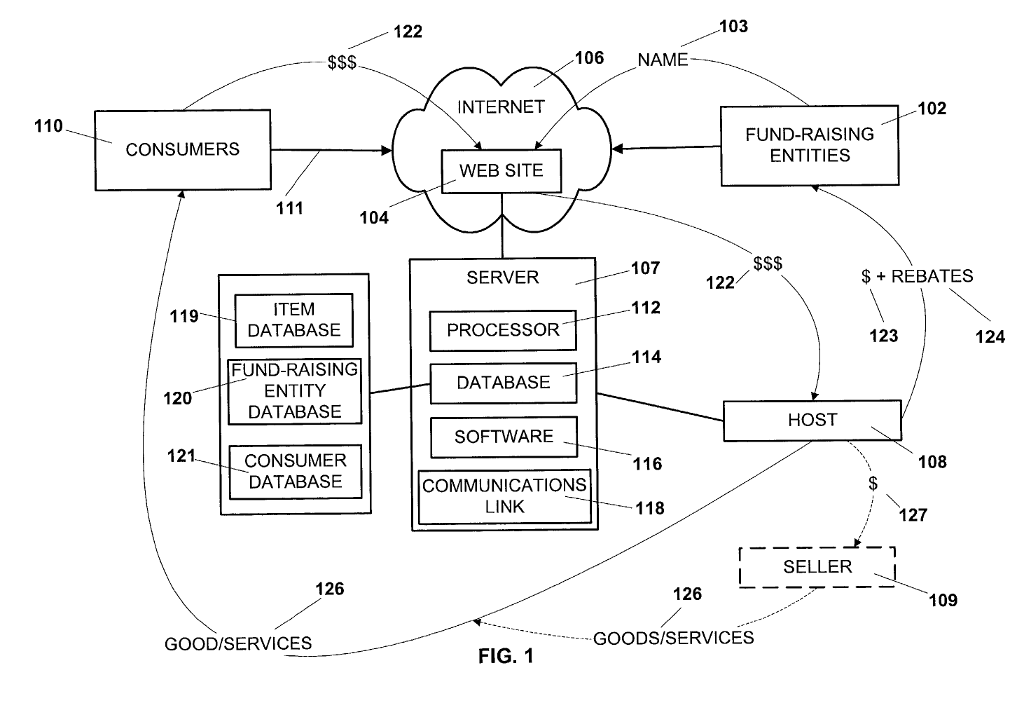

Reference is now made to FIG. 1, which is a block diagram illustrating the operation of a system in a preferred illustrative embodiment of the present invention. A fund-raising entity 102, such as a charity or non-profit organization, may contract with a host, or event or program planner 108, maintaining Web site 104 on the Internet 106, to organize and plan a fund-raising program which may include an auction or sale of goods or services 126, which in a preferred embodiment include artwork, collectibles, and memorabilia, for the benefit of or in the name of fund-raising entity 102. The goods or services for auction may be supplied by Web site host 108, or, alternatively, some other party. A manufacturer, for example, may sell goods to host 108 for the purpose of reselling. Host 108 benefits because consumers 110, knowing that a portion of the proceeds from each sale will go to the cause supported by fund-raising entity 102, will be encouraged to bid on or purchase items posted for auction or sale. Fund-raising entity 102 benefits because it is spared time and resources organizing an event and soliciting donations of items for auction. While host 108 is also the provider of the items for auction or sale in this preferred embodiment, a separate and distinct entity, such as seller 109, also could provide or own the goods and services for auction. In either case, fund-raising entity 102 is still spared the time and effort of soliciting donations of items for auction. In the event that fund-raising entity 102 receives items donated by others, these items may also be auctioned or sold for the benefit of fund-raising entity 102. Fund-raising entity 102 may hold both public on-line auctions (e.g., open to all network users) at Web site 104, or private auctions (e.g., requiring password for access). These auctions could be in lieu of a live auction event or to augment a live auction event.

The Web site, portal or other data management and processing site 104 maintained by the host 108 has servers 107 which may include processor 112, database 114, software programs 116, and communications link 118. Database 114 may include multiple component databases such as auction item database 119, for storing information related to items for auction (e.g., descriptions, pictures, prices), fund-raising organization database 120, for storing information related to the participating fund-raising entities (e.g., basic organization information, preferred logo for advertising, etc.), and consumer database 121, for storing information about consumers who are bidding on and purchasing items on Web site 104 (e.g., name, address, credit card information, etc.).

For example, site 104 may include a database 114 which has an “Event Planning Center” area, where fund-raising organization 102 can access information regarding the organization's program, activities, events and participation at site 104. Information available at the Event Planning Center of site 104 may include a running total of the proceeds generated during the organization's auction(s) to date, the number of events that the organization has held at site 104 and the proceeds generated for each, the number of rebate/discount points earned, identity information regarding those who have purchased items during the event (e.g., name, address, item(s) purchased), and other related information. The Web site 104 for example may allow fund-raising entity 102 to access or secure area of the Web site, through, for example passwords, in order to access information specific to their program. For example, a calendar function could be provided where a time line of milestones and events may be provided, persons with access to the calendar may for example make appointments for the access group, send and receive e-mails to/from the access group, participate in chatrooms, etc.

Host 108 provides the items for auction on site 104, and processor 112 of server 107 may display information regarding each item for auction. Alternatively, a seller 109 may contract with host 108 to provide the items for auction. Server 107 receives bids 111 for items from consumers 110 via communications link 118, and processor 112 running software 116 processes the bids and determines a winner for each item. It is also possible that multiple copies of the same item may be offered at auction so that a plurality of consumers posting the highest bids will win the items. In addition, multiple copies of a single item offered for auction may be offered for sale at a given price, also with a portion of the proceeds going to fund-raising entity 102. For example, if only a single, original, signed print from a well-known artist is offered at auction, multiple reproductions of this print may be offered for sale to consumers 110 in an “on-line gallery,” with a portion of the proceeds from each sale going to fund-raising entity 102.

In a preferred embodiment, the consumer 102 placing the winning bid will provide payment 122 to Web site 104, typically by means of a credit or debit card account, or any other means amenable to electronic transfer and processing. Processor 112 allocates a portion of payment 122 to the fund-raising entity, and the size of the portion may be determined in advance by agreement of the parties. The fund-raising portion of the auction proceeds 123 is provided to fund-raising entity 102, typically upon completion of the auction.

In addition, processor 112 may calculate the total revenue generated during the event or program, and provide fund-raising entity 102 with rebate points or a discount 124 based on the total revenue generated. This rebate or discount may be immediately redeemable by fund-raising entity 102 or applied at a later time toward the cost of a future fund-raising events. Rebate or discount 124 may be calculated according to different formulas depending upon whether the rebate is redeemed immediately or applied toward the cost of a future event so that an extra incentive may be provided to host another event. Alternatively, the rebate 124 may be based on the total volume of sales during the auction or at an on-line store provided at Web site 104, any live events or auctions or any combination thereof.

Once the payment 122 from consumer 110 has been collected and/or verified, the auction item (e.g., goods or services) 126 purchased is sent to consumer 110, either by host 108 or goods or services provider/seller 109. In the latter case, host 108 provides payment 127 to seller 109 who may send goods/services 126 directly to consumer 110. In one embodiment, consumers 110 may earn rebate points or dollars based on the number of items they purchase at Web site 104, where the rebate is applicable to future purchases at fund-raising Web site 104. Alternatively, the consumer rebate may be donatable to a consumer's favorite charity or other type of fund-raising organization. As an added advantage, one skilled in the art will recognize that Web site 104 and provider 108 may simultaneously host multiple auctions for different fund-raising organizations.

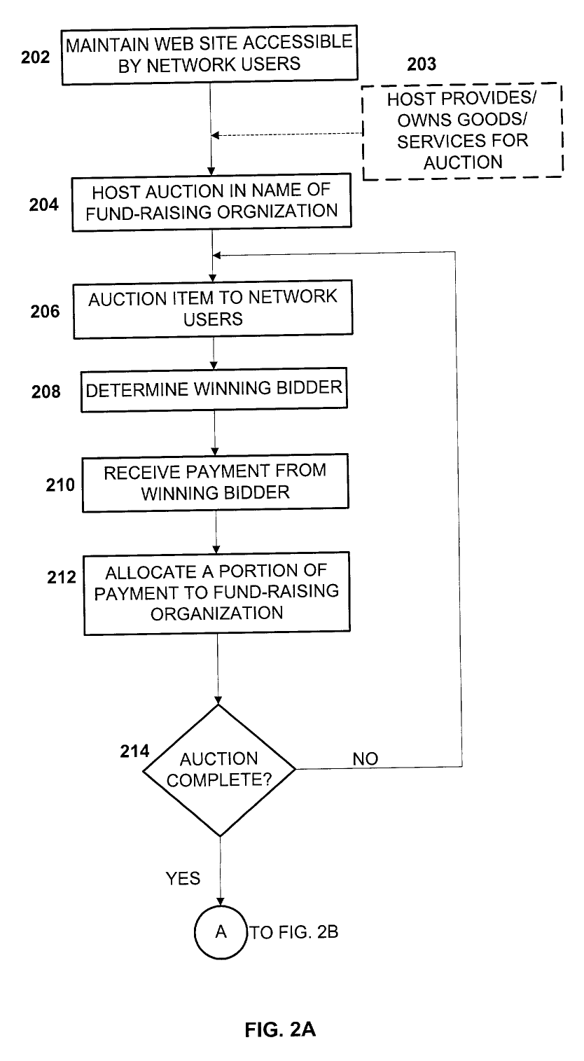

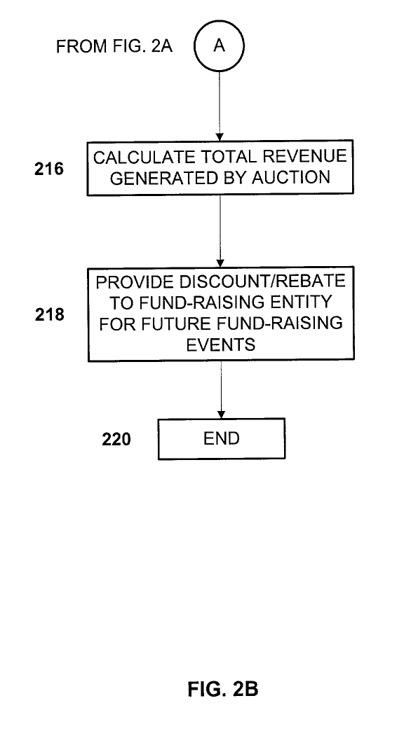

Reference is now made to FIGS. 2A and 2B, which are flowcharts illustrating the steps in a preferred embodiment of the method of one aspect of the present invention. In step 202, a Web site, portal or other data management and processing site, accessible by users of a communication link, such as the Internet, is provided. In step 204, a fund-raising entity agrees to “sponsor” a fund-raising auction at the host Web site, during which items preferably provided by another entity (e.g., NOT the fund-raising entity) are offered to consumers. As discussed above, in step 203, the items offered for auction preferably may be provided by the same entity that provides and maintains the Web site, or a separate entity. In step 206, items are auctioned on the Web site to network users. The auction may be public so that anyone visiting the Web site may register to bid on an item for auction by providing basic identity information (e.g., name, address, e-mail address, etc.) and a payment identifier, such as a credit or debit card number. Alternatively, the auction may be private—requiring a password and/or user name for access.

At some point, either after a certain amount of time has expired, or after a certain maximum bid has been reached, in step 208 a winning bidder is determined. It is contemplated that the auction will have a start time, end time, and a minimum opening bid. Further, after bidding, a consumer may be notified if their bid has been exceeded by another thus giving that consumer the opportunity to submit a higher bid. In step 210, payment from the winning bidder is received by the host Web site, and in step 212 a portion of the payment is allocated to the fund-raising cause. In step 214, if the auction is not complete, step 206 through 214 are repeated for other auction items. It should be obvious to one skilled in the art that while FIG. 2A presents the auction of items in a serial fashion, multiple items may be auctioned simultaneously during the same fund-raising auction, and multiple fund-raising auctions for different fund-raising entities may be held simultaneously at the same host Web site.

If the auction is complete in step 214, in step 216 (shown in FIG. 2B), the total revenue (e.g., gross sales) generated during the fund-raising event, which may be based on auction sales alone or combined with sales at a companion on-line store also provided at the host Web site or combined with a live auction, is calculated. In step 218, a discount or rebate, in the form of points, dollars, or some other means of quantification, is provided to the fund-raising entity, where the rebate may be a percentage of the total revenue generated during the fund-raising program or on-line fund raising event. Alternatively, steps 216 and 218 can be calculated after payment for each item so that the total revenue generated and rebate earned can be calculated on a running basis. The discount may be applied to the cost of future fund-raising events and/or may be used by the fund-raising entity to purchase goods for auction at future live or on-line fund-raising events.

While the present invention has been described with reference to the preferred embodiments, those skilled in the art will recognize that numerous variations and modifications may be made without departing from the scope of the present invention. Accordingly, it should be clearly understood that the embodiments of the invention described above are not intended as limitations on the scope of the invention, which is defined only by the claims as allowed.

What is claimed is:

1. In a communication network-based system, a method for administering an on-line find-raising event comprising:
maintaining a Web site accessible by network users;
hosting an on-line fund-raising auction of goods or services in the name of a fund-raising entity, the goods or services not owned or provided by the fund-raising entity;
auctioning the goods or services to users visiting the Web Site;
receiving payment from a user successfully bidding on a good or service for auction; and
allocating a portion of the payment to the fund-raising entity.

2. The method according to claim 1, wherein the goods or services to be auctioned are artwork, memorabilia, or collectibles.

3. The method according to claim 1, further comprising providing a rebate to the find-raising entity proportional to a total amount of revenue generated during a fund-raising event.

4. The method according to claim 3, wherein the rebate is applicable to a cost of future fund-raising events.

5. The method according to claim 1, further comprising providing a rebate to a network user who has purchased one or more auction items, the rebate applicable to future purchases at the Web site.

6. The method according to claim 1, wherein the goods or services are provided by an entity maintaining the Web site.

7. The method according to claim 1, wherein the communications network is the Internet.

8. The method according to claim 1, further comprising offering for sale at a fixed price items complementary or similar to the goods or services auctioned.

9. The method according to claim 1, wherein the fund-raising entity is a charity.

10. A communication network-based system for administering an on-line fund-raising event comprising:
a server computer for maintaining a Web site accessible by network users, the server computer including
a database for storing information related to fundraising entities and items for auction;
a communications link for receiving bids from users for auction items; and
a processor running software for displaying information about auction items, processing bids from network users, and determining winning bidders
wherein the Web site is configured to host an auction of goods or services in the name of a fund-raising entity, the goods or services not owned or provided by the fund-raising entity, the server computer receives payment from a user successfully bidding on a good or service for auction, and the processor allocates a portion of the payment to the fund-raising entity.

11. The system of claim 10, wherein the goods or services to be auctioned are artwork, memorabilia, or collectibles.

12. The system of claim 10, wherein the communications network is the Internet.

13. The system of claim 10, wherein the goods or services are provided by an entity maintaining the Web site.

14. The system of claim 10, wherein the fund-raising entity is a charity.

15. In a communication network-based system, a software program implemented on a host computer for administering an on-line fund-raising event, the software program configuring the host computer to:
maintain a Web site accessible by network users;
host a fund-raising auction of goods or services in the name of a fund-raising entity, the goods or services for auction not owned or provided by the fund-raising entity;
receive payment from a user successfully bidding on a good or service for auction; and
allocate a portion of the payment to the fund-raising entity.

16. The software program of claim 15, further configuring the host computer to: provide a rebate to the fund-raising entity proportional to a total amount of revenue generated during a fund-raising event.

17. The software program of claim 16, wherein the rebate is applicable to a cost of future fund-raising events.

18. The software program of claim 15, wherein the goods or services are provided by an entity maintaining the Web site.

19. The software program of claim 15, wherein the fund-raising entity is a charity.

20. In a communication network-based system, a method for administering an on-line fund-raising event for a charitable organization comprising:
contracting between a charitable organization and a host to organize a fundraising event;
maintaining a Web site by the host, the Web site accessible by network users;
hosting a fund-raising auction of goods or services for the benefit of the charity;
receiving payment from a user successfully bidding on a good or service for auction; and
allocating a portion of the payment to the charitable entity.

21. The method according to claim 20, further comprising providing goods or services owned by the host for auction.

22. The method according to claim 21, further comprising providing a rebate to the charitable entity proportional to a total amount of revenue generated during a fund-raising event.

23. The method according to claim 22, wherein the rebate is applicable to a cost of future fund-raising events.

24. The method according to claim 23, further comprising providing a rebate to a network user who has purchased one or more auction items, the rebate applicable to future purchases at the Web site.

25. The method according to claim 20, wherein the communications network is the Internet.
